(19) United States
(12) Patent Application Publication
(10) Pub. No.: US 2026/0269699 A1
(43) Pub. Date: Sep. 10, 2026

(54) ACTUATOR, FORCE DISPLAY DEVICE, AND OPERATION DEVICE

(71) Applicants: Yuki TAKAHASHI, Tokyo (JP); Kazutaka SAKAGUCHI, Tokyo (JP); Tomoya ISHITANI, Tokyo (JP)

(72) Inventors: Yuki TAKAHASHI, Tokyo (JP); Kazutaka SAKAGUCHI, Tokyo (JP); Tomoya ISHITANI, Tokyo (JP)

(73) Assignee: MITSUMI ELECTRIC CO., LTD., Tokyo (JP)

(21) Appl. No.: 19/509,992

(22) PCT Filed: Jul. 31, 2024
(86) PCT No.: PCT/JP2024/027323

§ 371 Date: Feb. 10, 2026

(30) Foreign Application Priority Data
Aug. 10, 2023 (JP) 2023-131509

(51) Int. Cl. H02K 33/16; B06B 1/04

(52) U.S. Cl. CPC H02K 33/16; B06B 1/045

(57) ABSTRACT

This actuator has: a movable body; a multi-axis rotation support part that supports the movable body so as to be rotatable around multiple axes; a fixed body to which the multi-axis rotation support part is attached; and a torque generation part that includes a magnet disposed on one of the movable body and the fixed body and a coil disposed on the other, and that by energizing the coil imparts rotation torque so that the movable body moves in an arc from an initial position.

### TECHNICAL FIELD

The present invention relates to an actuator, a force display device, and an operation apparatus.

### BACKGROUND ART

In the related art, as an apparatus that gives a user who carries an apparatus a sense of force in a predetermined direction, for example, a force display device as shown in Patent Literature (hereinafter, referred to as “PTL”) 1 is known. In the force display device of PTL 1, a magnet is fixed to a flat plate-shaped weight, a magnetic field is generated with a coil, and the magnet is caused to reciprocate in a predetermined direction to vibrate the weight, thereby presenting a force sense to a user.

### CITATION LIST

### Patent Literature

PTL 1

Japanese Patent No. 5898774

### SUMMARY OF INVENTION

### Technical Problem

Meanwhile, when implementing the above-described configuration, using a well-known slider crank mechanism is considered to use an apparatus that mechanically generates vibration, since specific structures such as a support structure of the magnet are not disclosed.

Since the apparatus generates vibration by reciprocating a slider using the slider crank mechanism, the size is large because a slider stroke needs to be large.

In addition, in a case of increasing the directional expression, a space for disposing a plurality of slider crank mechanisms is required, and the mounting size is further increased, which causes a problem of poor portability.

Objectives of the present invention include providing an actuator, a force display device, and an operation apparatus that can perform directional expression with a simple configuration at low cost and in a space-saving manner.

### Solution to Problem

An aspect of an actuator of the present invention is configured to include:
a movable body;
a multi-axis rotation supporting part that supports the movable body such that the movable body is rotatable about a plurality of axes;
a fixed body to which the multi-axis rotation supporting part is attached; and
a torque generation section that includes a magnet disposed on one of the movable body and the fixed body and a coil disposed on the other of the movable body and the fixed body, and that applies a rotational torque to the movable body upon energization of the coil such that the movable body moves in an arc shape from an initial position.

A vibration presentation apparatus of the present invention is configured to include:
the actuator having the above configuration; and
a housing in which the actuator is mounted and that includes a grip portion gripped by a user, in which
the movable body of the actuator is disposed to be movable in an outward direction with a center of gravity of the housing interposed between the movable body and the grip portion, the outward direction being a direction away from the center of gravity of the housing.

An operation apparatus of the present invention is configured to include:
the actuator having the above configuration, in which
the weight section is vibrated to perform force feedback by a torque generated by the torque generation section in response to movement of the weight section.

### Advantageous Effects of Invention

According to the present invention, directional expression can be performed with a simple configuration at low cost and in a space-saving manner.

### BRIEF DESCRIPTION OF DRAWINGS

FIG. 1 is an external perspective view of an actuator according to Embodiment 1 of the present invention;

FIG. 2 is a plan view of the actuator;

FIG. 3 is a front view of the actuator;

FIG. 4 is a sectional view taken along line A-A of FIG. 2;

FIG. 5 is an exploded perspective view of the actuator;

FIG. 6 is an exploded view of a fixed body and a movable supporting part of the actuator;

FIG. 7 is an exploded view of a movable body of the actuator;

FIG. 8 is a sectional view showing a configuration of a principal part of the actuator;

FIG. 9 is a diagram for describing an operation of the actuator;

FIG. 10A is an external perspective view of a variation of the actuator, and FIG. 10B is a longitudinal sectional view of the variation of the actuator;

FIG. 11 is an external perspective view of an actuator according to Embodiment 2 of the present invention;

FIG. 12 is a plan view of the actuator;

FIG. 13 is a front view of the actuator;

FIG. 14 is a sectional view taken along line B-B of FIG. 12;

FIG. 15 is an exploded perspective view of the actuator;

FIG. 16 is an exploded view of a fixed body and a movable supporting part of the actuator;

FIG. 17 is an exploded view of a movable body of the actuator;

FIG. 18 is a sectional view showing a configuration of a principal part of the actuator;

FIG. 19 is a diagram for describing an operation of the actuator;

FIG. 20A is an external perspective view of a variation of the actuator, and FIG. 20B is a longitudinal sectional view of the variation of the actuator;

FIG. 21 is a diagram showing an example of a force display device including the actuator;

FIG. 22 is a diagram for describing a force sense presentation mechanism of the force display device including the actuator; and

FIG. 23A is an external perspective view showing Variation 1 of the force display device including the actuator, and FIG. 23B is a front view of a variation 2 of the force display device.

### DESCRIPTION OF EMBODIMENTS

Hereinafter, embodiments of the present disclosure will be described in detail with reference to the drawings. In the drawings, the same reference numerals are given to the same components, and the description thereof will be omitted as appropriate.

In addition, in describing the structure of the actuator according to the present embodiment, a rectangular coordinate system (X, Y, Z) is used. The same rectangular coordinate system (X, Y, Z) is used in the drawings described below.

### Embodiment 1

### <Overall Configuration of Actuator>

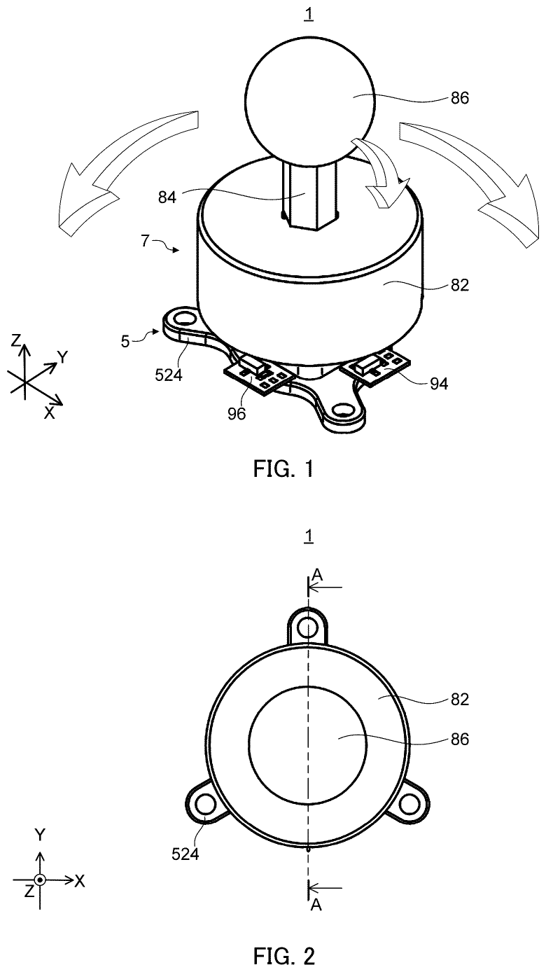

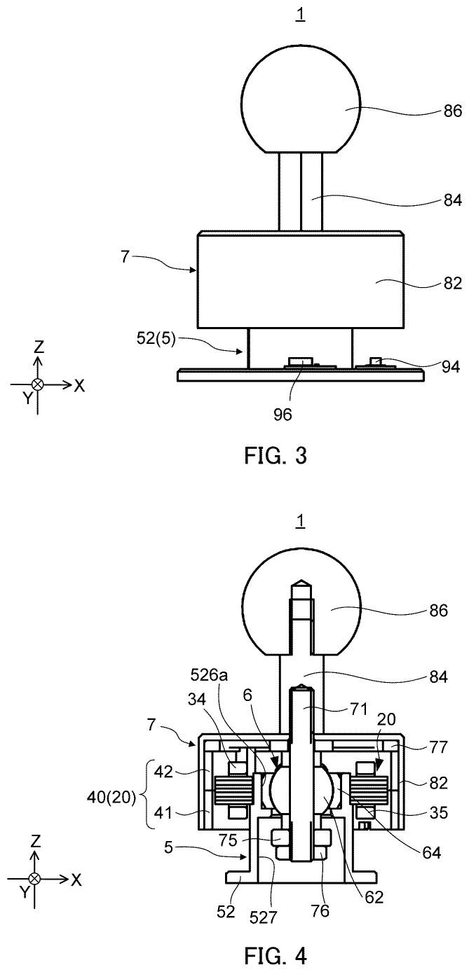

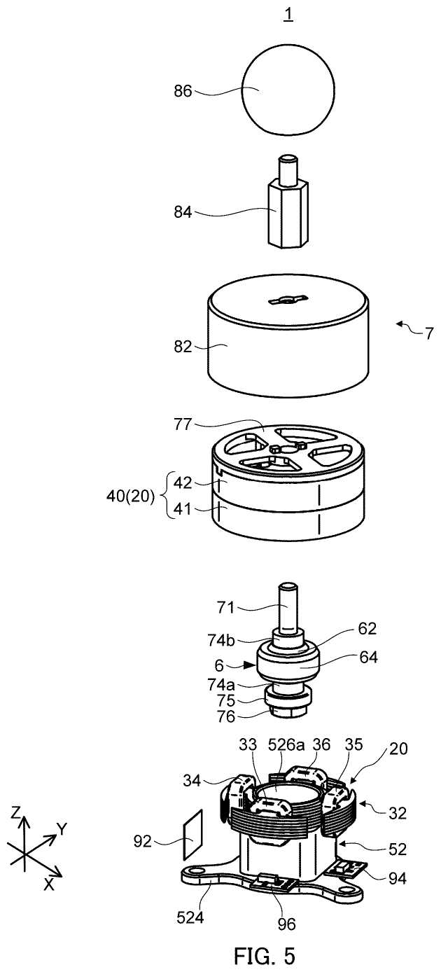

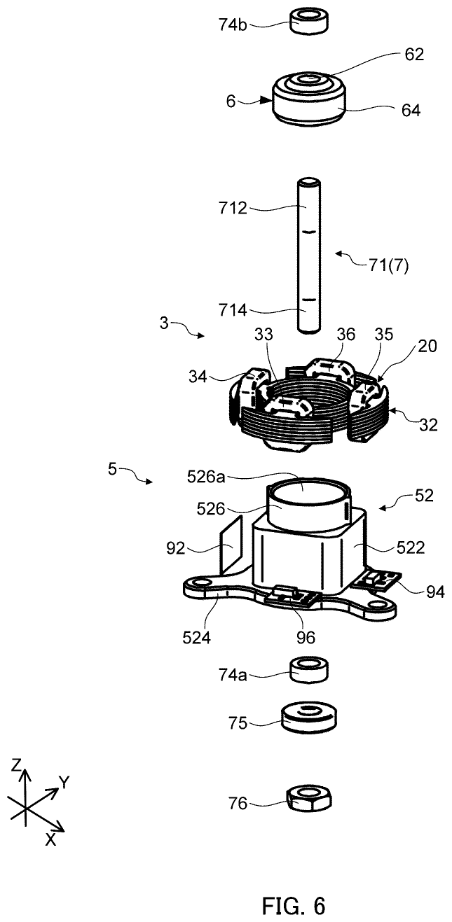

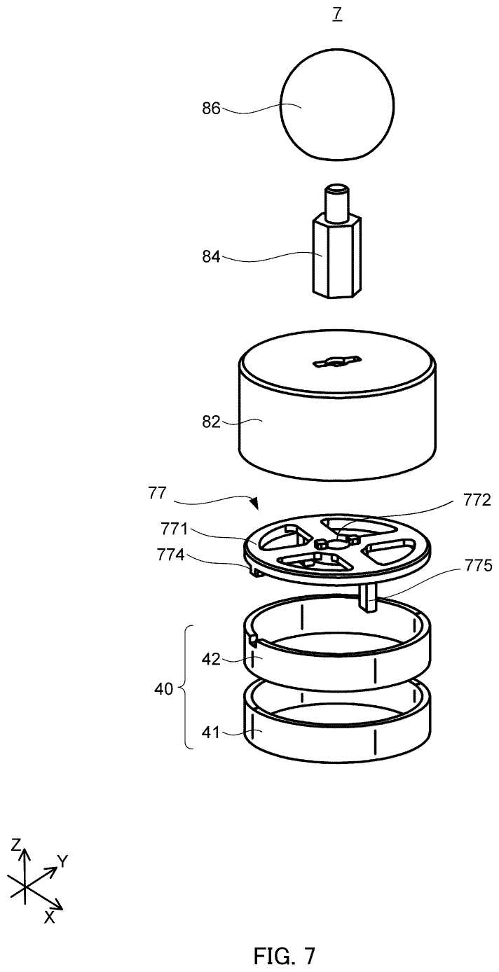

FIG. 1 is an external perspective view of an actuator according to Embodiment 1 of the present invention, FIG. 2 is a plan view of the actuator, and FIG. 3 is a front view of the actuator. In addition, FIG. 4 is a sectional view taken along line A-A of FIG. 2, FIG. 5 is an exploded perspective view of the actuator, FIG. 6 is an exploded view of a fixed body and a movable supporting part of the actuator, and FIG. 7 is an exploded view of a movable body of the actuator.

Actuator 1 shown in FIG. 1 is provided with weight section 86 that is protruded from an upper surface of case 82 to be movable reciprocally in four directions indicated by arrows with respect to housing 52 of fixed body 5, and weight section 86 can be moved such that weight section 86 can be displaced in all directions.

As shown in FIGS. 1 to 7, actuator 1 includes fixed body 5, movable body 7 including case 82 and weight section 86, multi-axis rotation supporting part 6 that supports movable body 7 such that the movable body is rotatable about a plurality of axes, and torque generation section 20 including coils 33 to 36 and magnets 40 (41 and 42).

Multi-axis rotation supporting part 6 is attached to fixed body 5, and movable body 7 is provided to be yawable about a Z axis with respect to fixed body 5 via multi-axis rotation supporting part 6. Multi-axis rotation supporting part 6 may be configured in any manner as long as movable body 7 is supported to be rotated about a plurality of axes, and for example, may be configured by using a spherical bearing or the like.

Torque generation section 20 includes core 32, coils 33 to 36, and magnet 40. Coils 33 to 36 constitute coil core section 3 together with core 32, and excite core 32 to function as an electromagnet together with core 32.

Coils 33 to 36 and magnet 40 are provided on one of movable body 7 or fixed body 5 and the other of movable body 7 or fixed body 5, respectively.

In coil core section 3, coils 33 to 36 are energized to cooperate with magnets 41 and 42 to function as torque generation section 20, and apply a rotational torque to movable body 7 such that movable body 7 moves in an arc shape (including reciprocating movement) from the initial position. Movable body 7 may be applied with the rotational torque to move from the axis of magnet 40 in a direction orthogonal to the axis.

In actuator 1, core 32 that is an inner core and around which coils 33 to 36 are wound is disposed inside magnets 41 and 42. The magnetic poles excited by coils 33 to 36 and the magnetic poles of magnets 41 and 42 are disposed to face each other in a radial direction.

As shown in FIGS. 5 to 7, actuator 1 includes coil core section 3, housing 52, nut 76, damper 75, rings 74a and 74b, and pivot shaft 71. Further, actuator 1 includes magnet 40, magnet spacer part 77, multi-axis rotation supporting part 6, case (rotor case) 82, shaft spacer 84 as a shaft adjustment part, and weight section 86.

Core 32 of coil core section 3 includes a tubular core body that is externally fitted to the outer peripheral portion of housing body 522 and a magnetic pole part that is provided to protrude from the outer periphery of the core body and around which coils 33 to 36 are wound. The distal end of the magnetic pole part has a magnetic pole surface portion that extends in the circumferential direction.

In coil core section 3, core 32 is attached to outer peripheral portion 526 of housing body 522, and the magnetic poles of core 32 are disposed to be arranged at equal intervals along the outer periphery from the upper portion (outer peripheral portion 526) of housing 52. The magnetic poles of core 32 may be one pole or may be a plurality of poles such as two poles or three poles, and for example, core 32 has four poles.

Housing 52 is a housing made of a resin such as polyphenylene sulfide (PPS).

In housing 52, a part of torque generation section 20 and a part (spherical bearing part 64 that receives shaft fixing part 62) of multi-axis rotation supporting part 6 are fixed. Housing 52 supports pivot shaft 71 such that the pivot shaft is rotatable about a plurality of axes via spherical bearing part 64.

Housing 52 includes housing body 522 and fixing portion support portion 524 that is fixed to housing body 522 and fixes actuator 1 to a product housing.

Housing body 522 is, for example, a rectangular tubular shape having a circular inner peripheral surface. Circular outer peripheral portion 526 is provided on the outer periphery of the upper portion of housing body 522. Spherical bearing part 64 of multi-axis rotation supporting part 6 is fixed in housing body 522 (including outer peripheral portion 526). Spherical bearing part 64 is disposed to be movable with pivot shaft 71 inserted into central opening portion 526a. An annular rib through which pivot shaft 71 is inserted is provided to protrude inward on an inner peripheral surface of opening portion 526a, and spherical bearing part 64 is attached to the rib.

Housing body 522 holds movable body 7 at a balanced position via multi-axis rotation supporting part 6 and coil core section 3.

Housing body 522 has rectangular outer peripheral portion 526 to which core 32 of coil core section 3 is externally fitted.

Relay board (wiring board) 92 that connects coil wires of coil end portions of coils 33 to 36 is attached to housing body 522. In addition, position detecting parts 94 and 96 that detect the position of the movable body are attached to housing 52. Position detecting parts 94 and 96 are, for example, Hall sensors using a Hall element, and measure and detect a change in magnetic flux in torque generation section 20. It is preferable that two or four position detecting parts 94 and 96 are provided.

Multi-axis rotation supporting part 6 includes shaft fixing part 62 into which pivot shaft 71 is inserted and fixed and which has a spherical (curved) outer peripheral surface, and spherical bearing part 64 that supports shaft fixing part 62 to be rotatable.

In multi-axis rotation supporting part 6, shaft fixing part 62 is supported to be rotatable by spherical bearing part 64, and supports pivot shaft 71 is thus supported to be movable in all directions from a state in which pivot shaft 71 is erected by supporting. Actuator 1 applies the rotational torque to pivot shaft 71 and movable body 7 (weight, case 82, and the like) via pivot shaft 71 to move pivot shaft 71 and movable body 7 in an arc shape (including reciprocating movement) from the initial position by torque generation section 20, via multi-axis rotation supporting part 6.

In multi-axis rotation supporting part 6, rings 74a and 74b through which pivot shaft 71 is inserted are disposed on both sides of shaft fixing part 62 through which pivot shaft 71 is inserted. In addition, multi-axis rotation supporting part 6 is fixed by disposing damper 75 adjacent to one ring 74a, by disposing damper 75, which has an outer diameter larger than that of ring 74a, on a base end portion side, and by fastening nut 76. Damper 75 may be configured in any manner as long the damper 75 attenuates an impact in a case of colliding with other members. Damper 75 may be formed of, for example, silicone rubber.

Pivot shaft 71 fixed to multi-axis rotation supporting part 6 is connected to weight section 86 via shaft spacer 84 at protruding distal end portion 712, and is supported by housing 52 in a state in which base end portion 714 to which damper 75 is attached protrudes from multi-axis rotation supporting part 6. Pivot shaft 71 is inserted into through-hole portion 527 that is continuous to a portion to which spherical bearing part 64 is attached in opening portion 526a.

As a result, even in a case in which pivot shaft 71 is moved beyond a movable region about multi-axis rotation supporting part 6 by an impact from the outside, damper 75 comes into contact with the inner peripheral surface of through-hole portion 527 in opening portion 526a, and the impact at the time of the contact can be alleviated.

Magnet 40 constitutes a magnetic spring for holding the position of movable body 7, particularly for holding the position of the movable body in a non-energized state, together with core 32 of coil core section 3.

Magnet 40 is attached to case 82 as an outer rotor. That is, magnet 40 is an outer magnet, and since magnet 40 itself can be increased in size even in the same size as a configuration in which magnet 40 is an inner magnet, an actuator with high conversion efficiency at high torque can be realized. In addition, the amplitude can be easily increased, and power consumption can be suppressed.

Magnet 40 is disposed to surround the outer periphery of coil core section 3 and is disposed at a position facing the magnetic poles of core 32. Magnet 40 is, for example, an Nd bond magnet, and an inertia as the movable body can be set.

Magnet 40 has a ring shape with respect to each magnetic pole of core 32 and is used as the movable body. Magnet 40 includes two magnets 41 and 42 arranged in the axial direction, has a plurality of magnetic pole pairs having different magnetic poles in the up-down direction at the inner periphery, and is provided such that the magnetic poles of each of the magnetic pole pairs are alternately different in the circumferential direction. In magnet 40, the magnetic poles are disposed in a lattice shape on the inner peripheral surface such that adjacent magnetic poles are different from each other.

The magnet is formed such that the magnetic poles of magnet 40 are magnetized in the axial direction of each magnetic pole of core 32. In magnet 40, magnets 41 and 42 constitute four sets of two poles (two poles facing each other in the axial direction) in the axial direction of coils 33 to 36.

Magnet 40 is disposed such that a pair of magnetic poles arranged in the up-down direction faces one magnetic pole of coil core section 3. Magnets 41 and 42 may be integrally formed. Further, magnet 40 may be formed by joining a plurality of magnetic pole pairs different in the axial direction (up-down direction) in the circumferential direction. In this case, magnet 40 has a ring shape and is integrally joined such that magnetic poles different in the circumferential direction are adjacent to each other.

In a case in which magnet 40 is configured as an integral ring shape, productivity is high, and a variation in an assembly dimension can be suppressed.

Magnet 40 functions as a magnetic spring by generating a magnetic attractive force with the magnetic poles of core 32, and moves the movable body to the initial position. Each magnetic pole of core 32 is disposed at a position facing in the magnetization direction of magnet 40, and pivot shaft 71 is disposed to extend in a direction orthogonal to the axis of coils 33 to 36. This state is a state in which the movable body is positioned at the initial position and is at a position that is a reference in an operation.

The reference position is located at the same distance regardless of the direction in which the pivot shaft rotates about multi-axis rotation supporting part 6.

Magnet 40 is attached to case (rotor case) 82 via magnet spacer part 77 in a state in which the height position is adjusted to correspond to the height of coil core section 3.

Magnet spacer part 77 has central hole 772 into which pivot shaft 71 is inserted at a central portion of body 771 having a predetermined thickness disposed in case 82.

Magnet spacer part 77 can perform positioning of magnet 40. Specifically, magnet spacer part 77 includes protrusion 774 that engages with a recessed portion of the upper surface of magnet 42 and rod portion 775 that extends to the inside of magnet 40 and comes into contact with the inside of magnet 42. Protrusion 774 restricts rotation in the circumferential direction of components. Rod portion 775 is disposed to have a gap inside core 32. As a result, in a case in which movable body 7 is rotated about the axis or inclined in the driving direction up to a predetermined position, rod portion 775 comes into contact with core 32 and functions as a hard stop.

In addition, the thickness of body 771 can set the axial height position of magnet 40 with respect to case 82 (specifically, the upper surface of case 82). As a result, by adjusting the height position of coil core section 3, magnet spacer part 77 makes it possible to attach magnet 40 and coil core section 3 to case 82 in a desired positional relationship.

Magnet spacer part 77 is preferably made of a non-magnetic material and may be made of polyphenylene sulfide (PPS) or the like.

Case 82 is a rotor case that is a rotor body. Case 82 is a magnetic material and is formed of, for example, an electrically galvanized steel plate (SECE). Case 82 covers magnet 40 and coil core section 3 and forms a magnetic path together with magnet 40 and coil core section 3.

Pivot shaft 71 is connected inside case 82, and shaft spacer 84 is connected on an outer surface side. Weight section 86 is connected via shaft spacer 84.

Pivot shaft 71 is inserted into an opening portion of case 82 with the distal end portion 712 thereof and is protruded from a surface of case 82, and is screwed and bonded to a base end portion of shaft spacer 84.

As a result, the entire rotor that is the movable body is fastened to case 82.

In shaft spacer 84, the distal end portion is detachably attached to weight section 86, and the base end portion is joined to pivot shaft 71 with case 82 interposed therebetween. Shaft spacer 84 has a function as the shaft adjustment part that can adjust the distance from case 82 to weight section 86 by changing the length of the shaft.

As a result, when weight section 86 is spaced from case 82, that is, from the rotation center via shaft spacer 84, the increased inertia can be set to a desired value to provide suitable for vibration.

In addition, since the position of weight section 86 can be adjusted, it is possible to improve the ease of suppressing and verifying the variation. Weight section 86 can adjust the inertia by spacing the position from the rotation center, and can adjust the inertia to an optimal position.

For example, by disposing weight section 86 at a position at a predetermined distance from the rotation center, the inertia can be increased with a small-sized weight, and the tactile sensation of directional expression can be optimized.

Weight section 86 is made of a material such as a SUS material and may be made of a high specific gravity material.

Since weight section 86 is provided on the outer surface of the rotor, it is possible to avoid interference with other components as compared with a configuration in which weight section 86 is disposed inside the rotor.

### <Operation>

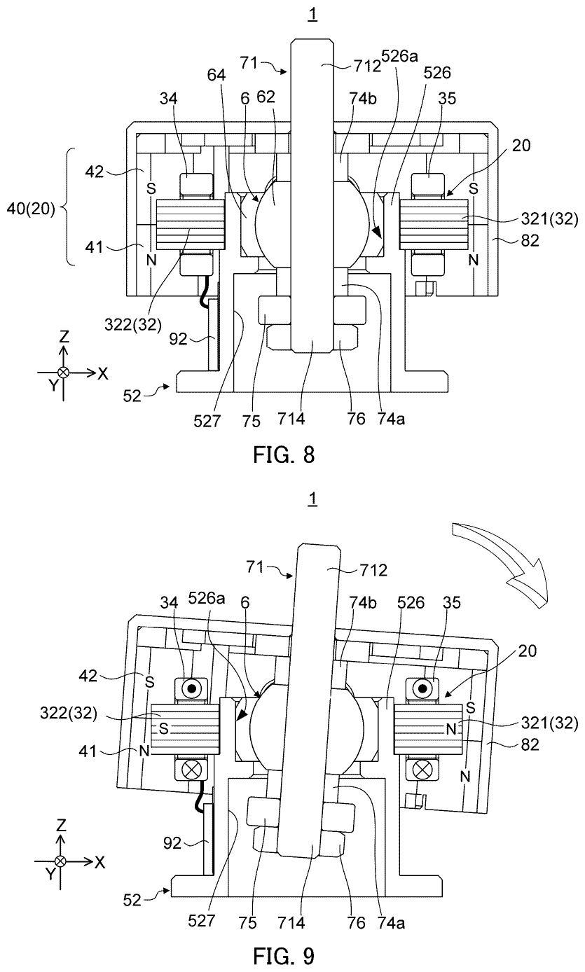

FIG. 8 is a sectional view showing a configuration of a principal part of the actuator, and FIG. 9 is a diagram for describing an operation of the actuator according to Embodiment 1. For convenience, the weight is omitted. In addition, magnet 40 has different magnetic poles in each of magnets 41 and 42, and the magnetic poles facing each other across the axis of the actuator in magnet 41 are N poles, and the magnetic poles facing each other across the axis of the actuator in magnet 42 are S poles.

In actuator 1, as shown in FIG. 8, in a case in which coils 33 to 36 are in a non-energized state, the magnetic poles (321 and 322) of core 32 are attracted to the magnetic attractive force of magnets 41 and 42 closest in distance.

The magnetic poles of core 32 that are not magnetized are attracted to the magnetic poles of the inner peripheral surfaces of cylindrical magnets 41 and 42 in four directions about pivot shaft 71. As a result, the distance from each magnetic pole 321 and 322 of core 32 to the magnetic poles (inner peripheral surface) of magnet 40 about multi-axis rotation supporting part 6 is the same distance, and the state in which the core is in the state of being disposed at the initial position is achieved.

Then, core 32 is excited by energizing the coils (34 and 35) via relay board 92. As shown in FIG. 9, in a case in which coils 34 and 35 are energized, coil core section 3 becomes an electromagnet in which magnetic pole 321 of the core is an N pole and magnetic pole 322 is an S pole, and is attracted to and repelled from the magnetic poles of magnets 41 and 42. As a result, one side of the opposite sides of pivot shaft 71 is moved upward and the other side is moved downward to rotate pivot shaft 71 in the arrow direction.

In actuator 1, since four cores 32 have magnetic poles and each of cores 32 is an electromagnet that generates a magnetic force, power can be supplied to generate a magnetic force in various combinations of energizing or not energizing each of cores 32 as appropriate. Pivot shaft 71 can be moved in various ways such as reciprocally pivot in a vertical plane in one direction, performing a yawing operation, or vibrating in two axial directions. In addition, it is possible to generate vibration by slow movement in one direction and movement in a direction opposite to the one direction that is faster than the slow movement in one direction.

According to the present embodiment, vibration in two directions of a plane can be generated, and the expression of the direction can be suitably performed.

According to the present embodiment, directional expression can be performed with a simple configuration at low cost and in a space-saving manner. In addition, in the present embodiment, since position detecting parts 94 and 96 are provided, in a case in which weight section 86 is applied as a tactile sensation presentation apparatus with weight section 86 as an operation section, vibration corresponding to the position of the operated operation section may be generated and applied to the user via the operation section. Since actuator 1 can detect the operation position in this way, actuator 1 can be used as an input apparatus having both functions of input and force feedback.

In addition, as the directional expression, actuator 1 may perform force feedback of applying vibration in response to the operation of weight section 86 as the operation section, in addition to the vibrotactile sensation. Weight section 86 is used as an operation section that can be adjusted by being displaced, and in a case in which weight section 86 is operated by being touched, vibration in two rotation directions can be generated to perform force feedback.

It is preferable that the resonance frequency at which the power is supplied to coils 33 to 36 via relay board 92 is a frequency at which movable body 7 is driven at a frequency of 150 Hz or less such that actuator 1 has a resonance structure of 150 Hz or less. For example, the resonance frequency of the movable body is mainly about 50 Hz or less, and is further preferably 20 Hz or less. In addition, the resonance frequency is preferably 1 or more, and may be, for example, 5 Hz. Further, the resonance frequency may be 10 to 20 Hz. In addition, actuator 1 may be driven at 5 Hz or 10 Hz, and can be more effectively driven at 5 Hz to 10 Hz. As a result, the vibration period of the directional expression can be reduced, and a variation-rich vibration with a clear directional expression can be generated, including weak vibration that is difficult to realize with a mechanical spring. Relay board 92 may have a control section that controls the actuator by mounting a microcomputer, an actuator driver, and the like. In the control section, torque generation section 20 is driven by supplying power to coils 33 to 36 as described above to perform the directional expression. In addition, the control section can control the movement of movable body 7 by energizing coils 33 to 36 via position detecting parts 94 and 96. The control section may not be provided on relay board 92 or actuator 1.

In addition, the input signal supplied to coils 33 to 36 in a case of driving actuator 1 is preferably a signal waveform that is asymmetric between positive and negative polarities and is a signal that causes actuator 1 to vibrate asymmetrically such that the speed is different between respective driving directions. For example, the signal is a sawtooth wave. As a result, the direction can be clearly expressed by moving the movable part slowly on one side and quickly on the other side to produce a tactile sensation, and in a case of the sawtooth wave, a movement that is most clearly exhibited can be provided, and an excellent directional expression can be performed.

### <Variation 1>

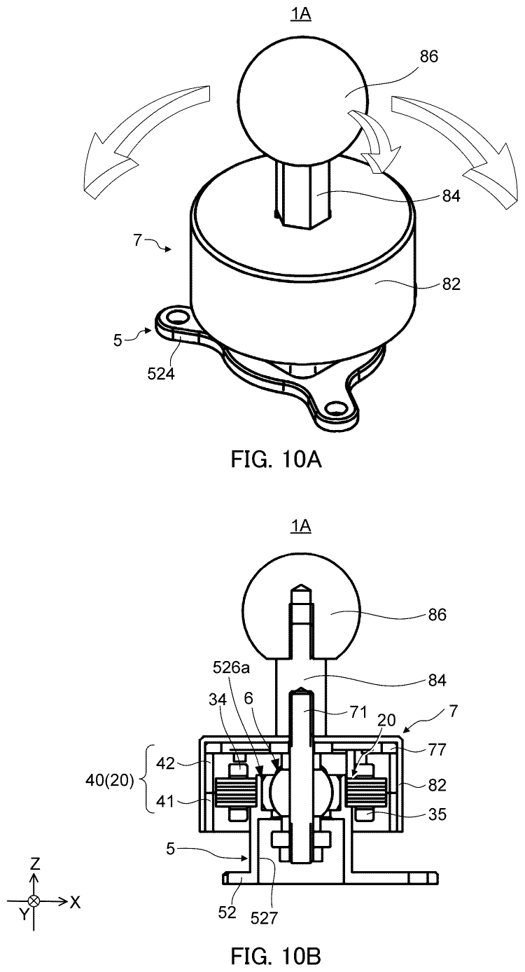

FIG. 10A is an external perspective view of a variation of the actuator, and FIG. 10B is a longitudinal sectional view of the variation of the actuator.

Actuator 1A shown in FIG. 10 is actuator 1A that does not have position detecting parts 94 and 96 in the configuration of actuator 1. Since actuator 1A has the same operation and effect as actuator 1, actuator 1A can be applied to an apparatus that presents a simpler directional expression.

### Embodiment 2

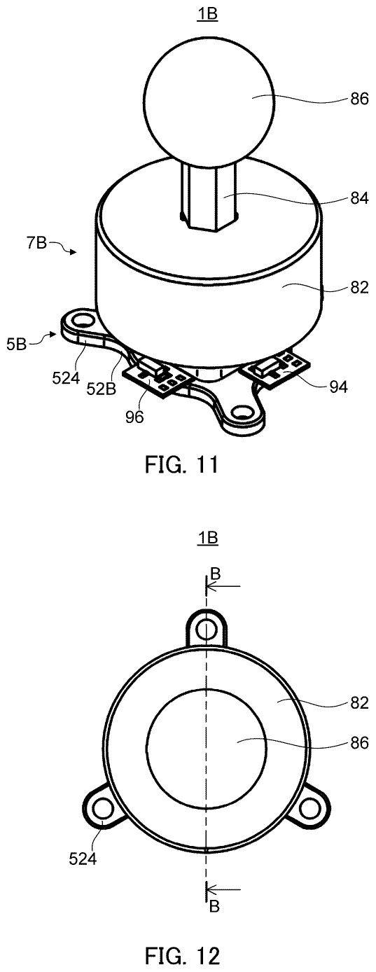

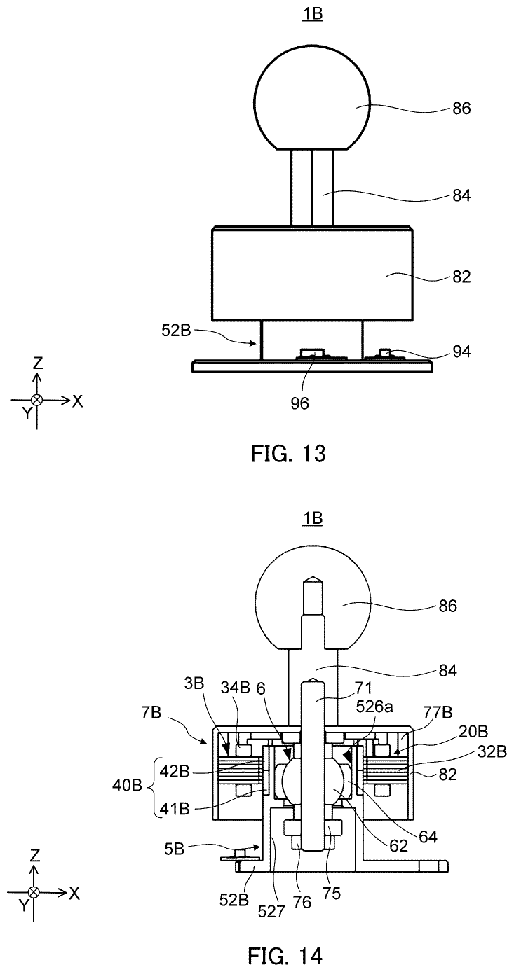

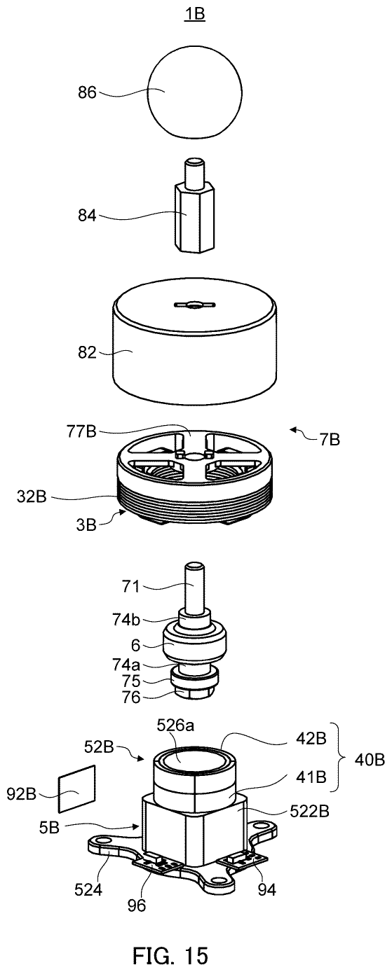

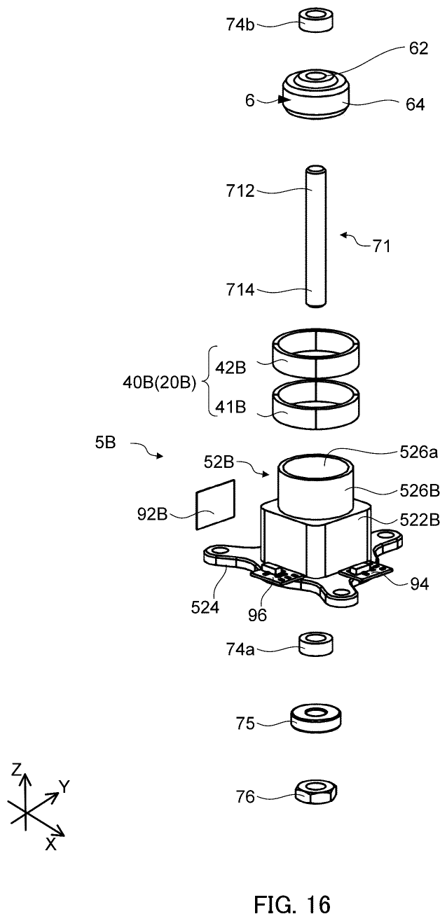

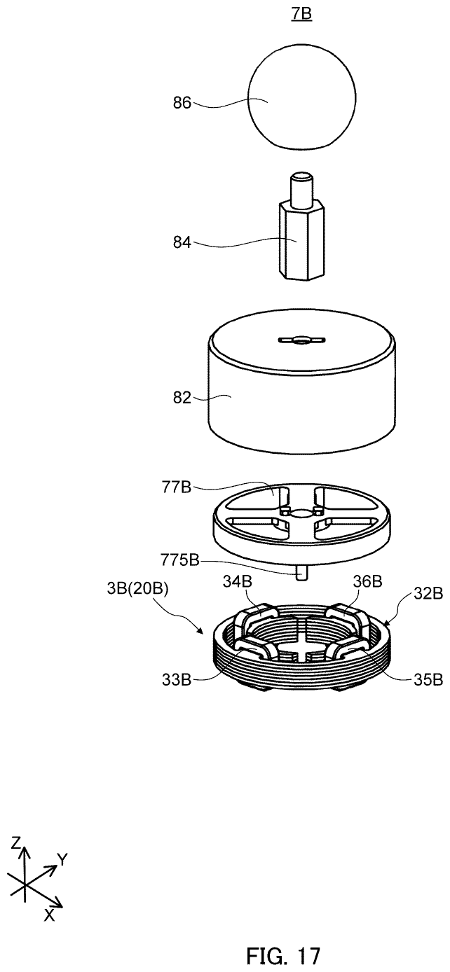

FIG. 11 is an external perspective view of an actuator according to Embodiment 2 of the present invention, FIG. 12 is a plan view of the actuator, and FIG. 13 is a front view of the actuator. In addition, FIG. 14 is a sectional view taken along line B-B of FIG. 12, FIG. 15 is an exploded perspective view of the actuator, FIG. 16 is an exploded view of a fixed body and a movable supporting part of the actuator, and FIG. 17 is an exploded view of a movable body of the actuator.

Actuator 1B shown in FIG. 11 has the same appearance as actuator 1 of FIG. 1, and is provided with weight section 86 that is protruded from the upper surface of case 82 to be movable reciprocally in all directions indicated by arrow directions with respect to housing 52B of fixed body 5B.

The difference between actuator 1B and actuator 1 is that actuator 1 has a moving magnet structure, whereas actuator 1B has a moving coil structure.

As shown in FIGS. 11 to 17, actuator 1B includes fixed body 5B, movable body 7B including case 82 and weight section 86, multi-axis rotation supporting part 6 that supports movable body 7B such that the movable body is rotatable about a plurality of axes, and torque generation section 20B including coils 33B to 36B and magnets 40B (41B and 42B).

Hereinafter, only different configurations will be described, and the description of the same configurations will be omitted.

Multi-axis rotation supporting part 6 is attached to fixed body 5B, and movable body 7B is provided to be yawable about the Z axis with respect to fixed body 5B via multi-axis rotation supporting part 6.

Torque generation section 20B includes core 32B, coils 33B to 36B, and magnet 40B. Coils 33B to 36B constitute coil core section 3B together with core 32B, and excite core 32B to function as an electromagnet together with core 32B.

Coils 33B to 36B are provided on movable body 7B, and magnet 40B is provided on fixed body 5B.

In coil core section 3B, coils 33B to 36B are energized to cooperate with magnets 41B and 42B to apply a rotational torque to movable body 7B such that movable body 7B moves in a direction orthogonal to the axis of magnet 40B.

In actuator 1B, core 32B that is an outer core and around which coils 33B to 36B are wound is disposed outside magnets 41B and 42B.

The magnetic poles excited by coils 33B to 36B and the magnetic poles of magnets 41B and 42B are disposed to face each other in a radial direction.

As shown in FIGS. 15 to 17, actuator 1B includes coil core section 3B, housing 52B, nut 76, damper 75, rings 74a and 74b, pivot shaft 71, magnet 40B, core spacer part 77B, multi-axis rotation supporting part 6, case 82, shaft spacer 84, and weight section 86.

Core 32B of coil core section 3B is disposed inside a peripheral wall of case 82 together with core spacer part 77B. Core spacer part 77B includes the same rod portion 775B and the like as magnet spacer part 77 (see FIG. 7). Rod portion 775B is disposed to have a gap inside core 32B and when movable body 7B is rotated about the axis or inclined in the driving direction up to a predetermined position, rod portion 775B comes into contact with core 32B and functions as a hard stop.

Core 32B has a magnetic pole that protrudes from an inner periphery of a cylindrical core body that comes into contact with an inner peripheral surface of case 82 on an outer peripheral surface, and coils 33B to 36B are wound around each magnetic pole to constitute a magnetic pole part. The distal end of the magnetic pole part has a magnetic pole surface portion that extends in the circumferential direction.

In housing 52B that has the same configuration as housing 52, magnet 40B instead of the core is attached to outer peripheral portion 526B of housing body 522B. In addition, a part (spherical bearing part 64 that receives shaft fixing part 62) of multi-axis rotation supporting part 6 is fixed in opening portion 526a.

Housing 52B supports pivot shaft 71 such that the pivot shaft is rotatable about a plurality of axes via spherical bearing part 64.

Relay board (wiring board) 92B that connects coil wires of coil end portions of coils 33B to 36B is attached to housing body 522B. In addition, position detecting parts 94 and 96 that detect the position of the movable body are attached to housing 52B. Position detecting parts 94 and 96 are, for example, Hall sensors using a Hall element, and measure and detect a change in magnetic flux in the torque generation section. It is preferable that two or four position detecting parts 94 and 96 are provided.

Pivot shaft 71 fixed to multi-axis rotation supporting part 6 is connected to weight section 86 via shaft spacer 84 at protruding distal end portion 712, and is supported by housing 52B in a state in which base end portion 714 to which damper 75 is attached protrudes from multi-axis rotation supporting part 6. Pivot shaft 71 is inserted into through-hole portion 527 that is continuous to a portion to which spherical bearing part 64 is attached in opening portion 526a.

As a result, even in a case in which pivot shaft 71 is moved by an impact from the outside by a movable region or more about multi-axis rotation supporting part 6, damper 75 comes into contact with the inner peripheral surface of through-hole portion 527 in opening portion 526a, and the impact at the time of the contact can be alleviated.

Magnet 40B constitutes a magnetic spring for holding the position of movable body 7B, particularly for holding the position of the movable body in a non-energized state, together with core 32B of coil core section 3B.

As described above, magnet 40B is disposed inside coil core section 3B and is disposed at a position facing the magnetic poles of core 32B.

Magnet 40B has a ring shape with respect to each magnetic pole of core 32B and is used as the fixed body. Magnet 40B includes two magnets 41B and 42B arranged in the axial direction, has a plurality of magnetic pole pairs having different magnetic poles in the up-down direction at the outer periphery, and is provided such that the magnetic poles of each of the magnetic pole pairs are alternately different in the circumferential direction. In magnet 40B, the magnetic poles are disposed in a lattice shape on the outer peripheral surface such that adjacent magnetic poles are different from each other.

The magnetic poles of magnet 40B are magnetized in the axial direction of each magnetic pole of core 32B to be formed. In magnet 40B, magnets 41B and 42B constitute four sets of two poles of the coils 33B to 36B in the axial direction.

Magnet 40B is disposed such that the magnetic pole pairs arranged in the up-down direction face one magnetic pole of coil core section 3B. Magnets 41B and 42B may be integrally formed. Further, magnet 40B may be formed by joining a plurality of magnetic pole pairs different in the axial direction (up-down direction) in the circumferential direction. In this case, magnet 40B has a ring shape and is integrally joined such that magnetic poles different in the circumferential direction are adjacent to each other.

In a case in which magnet 40B is configured as an integral ring shape, productivity is high, and a variation in an assembly dimension can be suppressed.

Magnet 40B functions as a magnetic spring by generating a magnetic attractive force with the magnetic poles of core 32B, and moves the movable body to the initial position. Each magnetic pole of core 32B is disposed at a position facing the magnetization direction of the magnet, and pivot shaft 71 is disposed to extend in a direction orthogonal to the axis of coils 33B to 36B. This state is a state in which the movable body is positioned at the initial position and is at a position that is a reference in an operation.

The other configurations are the same as those of actuator 1, and thus the description thereof will be omitted.

### <Operation>

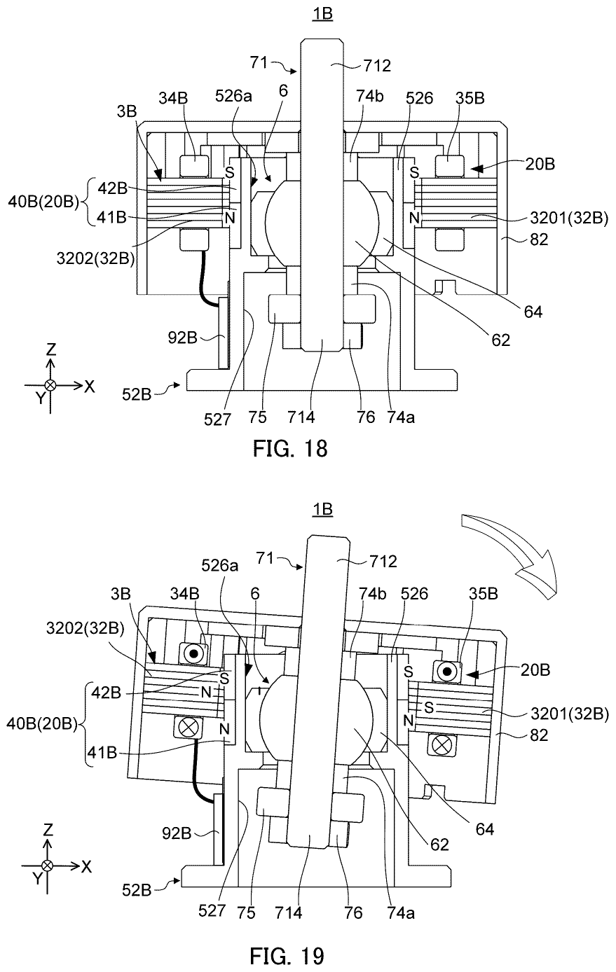

FIG. 18 is a sectional view showing a configuration of a principal part of the actuator, and FIG. 19 is a diagram for describing an operation of the actuator. For convenience, the weight is omitted. In addition, magnet 40B has different magnetic poles in the up-down direction on the same outer peripheral surface of magnets 41B and 42B, and is also disposed to have upper and lower magnetic poles different in the circumferential direction. The magnetic poles facing each other across the axis of the actuator in magnet 41B are N poles, and the magnetic poles facing each other across the axis of the actuator in magnet 42B are S poles.

In actuator 1B, as shown in FIG. 18, in a case in which coils 33B to 36B are in a non-energized state, the magnetic poles (3201 and 3202) of core 32B are attracted by the magnetic attractive force toward respective ones of magnets 41B and 42B that face the magnetic poles and are positioned closest thereto.

The magnetic poles of core 32B that are not magnetized are attracted to the magnetic poles of the inner peripheral surfaces of cylindrical magnets 41B and 42B in four directions about pivot shaft 71. As a result, the distance from each magnetic pole 3201 and 3202 of core 32B to the magnetic poles (inner peripheral surface) of magnet 40B about multi-axis rotation supporting part 6 is the same distance, and the state in which the core is in the state of being disposed at the initial position is achieved.

Then, actuator 1B is driven in the same manner as actuator 1 by energizing coils 34B and 35B via relay board 92B, and has the same function. In particular, the directional vibration can be generated, and the directional expression can be suitably performed.

According to the present embodiment, directional expression can be performed with a simple configuration at low cost and in a space-saving manner. In addition, in the present embodiment, since position detecting parts 94 and 96 are provided, in a case in which weight section 86 is applied as a tactile sensation presentation apparatus with weight section 86 as an operation section, vibration corresponding to the position of the operated operation section may be generated and applied to the user via the operation section.

The resonance frequency at which the power is supplied to coils 33B to 36B via relay board 92B is the same as that of actuator 1, and thus the description thereof will be omitted.

### <Variation 2>

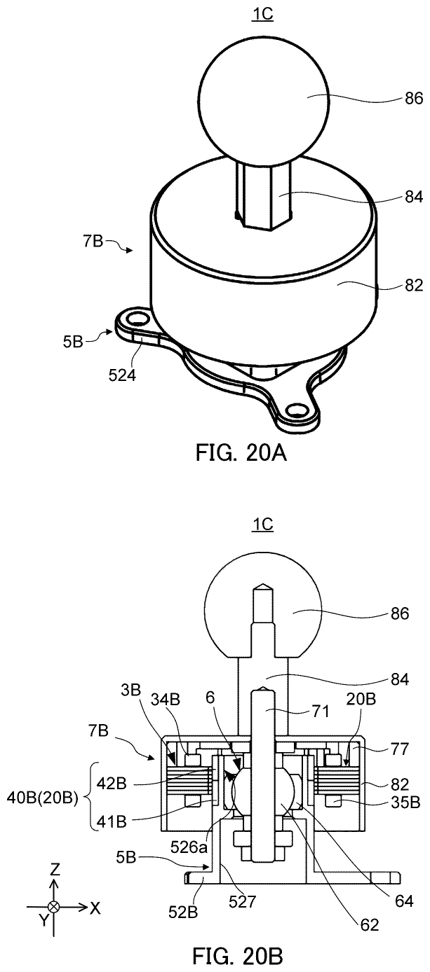

FIG. 20A is an external perspective view of a variation of the actuator, and FIG. 20B is a longitudinal sectional view of the variation of the actuator.

Actuator 1C shown in FIG. 20 is actuator 1C that does not have position detecting parts 94 and 96 in the configuration of actuator 1B. Since actuator 1C has the same operation and effect as actuators 1 and 1B, actuator 1C can be applied to an apparatus that presents a simpler directional expression.

### <Force Display Device>

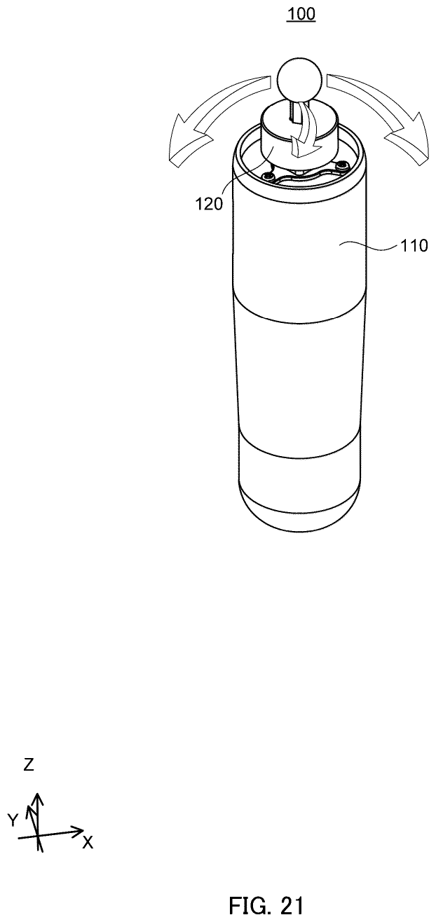

FIG. 21 is a diagram showing an example of a force display device including an actuator. Force display device 100 shown in FIG. 21 includes housing 110 that has a built-in power supply such as a battery, and actuator 120 provided on housing 110. Actuator 120 may be any of actuators 1, 1A, 1B, or 1C.

In force display device 100, a fixed body of actuator 120 is attached to one end surface portion of rod-shaped housing 110 that is easy to grip. In addition, force display device 100 may be used as an apparatus that is gripped by a user, such as a game controller, to present a tactile sensation by generating vibration, or as an operation apparatus that is operated by weight section 86.

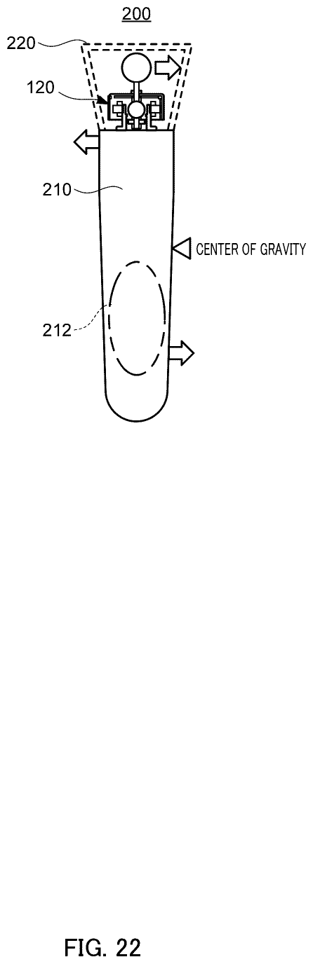

FIG. 22 is a diagram for describing a force sense presentation mechanism of the force display device including the actuator. In force display device 200, as shown in FIG. 22, actuator 120 is attached to one end portion of rod-shaped housing 210, and movable body 7 (for example, weight section 86) in this case is disposed outward from the center of gravity of an installation housing, and grip portion 212 that performs the tactile sensation presentation is disposed on the opposite side of multi-axis rotation supporting part 6 from movable body 7.

By setting grip portion 212, which is a tactile sensation presentation section, to a predetermined position, vibration in a desired direction can be generated, and the amplitude can be increased to further enhance the directional expression. Actuator 120 may be configured to be covered by a hood 220. As a result, by making actuator 1 visually recognizable, the vibration expression can be performed on the force sense different from a case in which actuator 1 can be visually recognized.

### <Variation 1 of Force Display Device>

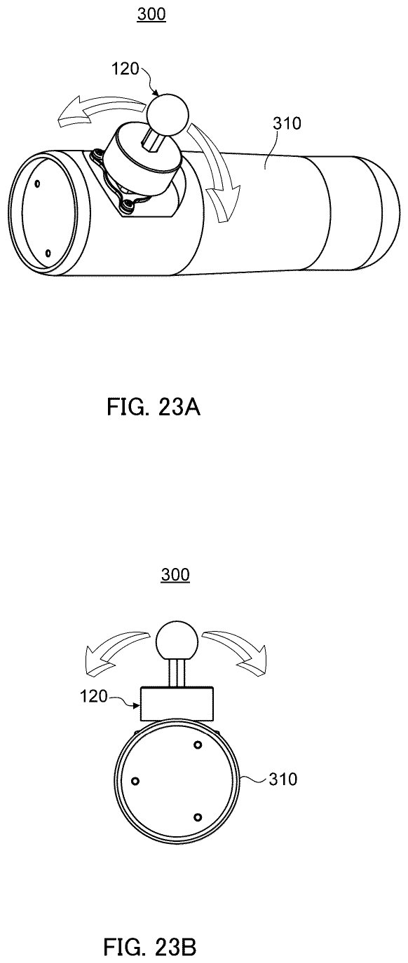

FIG. 23A is an external perspective view showing Variation 1 of the force display device including the actuator, and FIG. 23B is a front view of Variation 1 of the force display device.

Force display device 300 shown in FIGS. 23A and 23B has a configuration in which actuator 120 is disposed on a part of a peripheral wall of cylindrical housing 310. As a result, force display device 300 can perform the directional expression in two directions along the axis of housing 310 by moving the movable body. That is, actuator 120 can perform the directional expression according to the shape of the housing to be attached. In this case, the directional expression can be performed more effectively in accordance with a way of holding housing 310. Force display devices 100, 200, and 300 may be used as a vibration presentation apparatus.

The embodiments of the present invention have been described above. The above description is an example of a suitable embodiment of the present invention, and the scope of the present invention is not limited thereto. That is, the description of the configuration of the apparatus and the shape of each portion is an example, and it is clear that various changes and additions to these examples are possible within the scope of the present invention.

The disclosure of the specification, drawings, and abstract of the Japanese patent application No. 2023-131509 filed on Aug. 10, 2023 is incorporated in the present application by reference.

### Industrial Applicability

The actuator and the operation apparatus according to the present invention have an effect of being able to perform the directional expression with a simple configuration at low cost and in a space-saving manner, and are useful as a tactile sensation presentation apparatus such as a directional expression presentation apparatus and a force display device.

### REFERENCE SIGNS LIST

1, 1A, 1B, 1C, 120 Actuator
3, 3B Coil core section
5, 5B Fixed body
6 Multi-axis rotation supporting part
7, 7B Movable body
20, 20B Torque generation section
32, 32B Core
321, 322 Magnetic pole
33, 33B, 34, 34B, 35, 35B, 36, 36B Coil
40, 40B, 41, 41B, 42, 42B Magnet
52, 52B Housing
62 Shaft fixing part
64 Spherical bearing part
71 Pivot shaft
74a, 74b Ring
75 Damper
76 Nut
77 Magnet spacer part
77B Core spacer part
82 Case
84 Shaft spacer
86 Weight section
92, 92B Relay board (wiring board)
94, 96 Position detecting part
100, 200, 300 Force display device
110, 210, 310 Housing
212 Grip portion
220 Hood
321, 322, 3201, 3202 Magnetic pole
522, 522B Housing body
524 Fixing portion support portion
526 Outer peripheral portion
526a Opening portion
526B Outer peripheral portion
712 Distal end portion
714 Base end portion
771 Body
772 Central hole
774 Protrusion
775 Rod portion

1. An actuator, comprising:
a movable body;
a multi-axis rotation supporting part that supports the movable body such that the movable body is rotatable about a plurality of axes;
a fixed body to which the multi-axis rotation supporting part is attached; and
a torque generation section that includes a magnet disposed on one of the movable body and the fixed body and a coil disposed on the other of the movable body and the fixed body, and that applies a rotational torque to the movable body upon energization of the coil such that the movable body moves in an arc shape from an initial position.

2. The actuator according to claim 1, wherein:
the multi-axis rotation supporting part includes a pivot shaft connected to the movable body positioned at the initial position; and
the torque generation section generates a torque with respect to the pivot shaft in a direction orthogonal to the pivot shaft.

3. The actuator according to claim 1, wherein:
the coil is disposed on a core;
the magnet is magnetized to have different poles in an axial direction with respect to the core; and
the core has a plurality of core magnetic poles that straddle an axial position, and the plurality of core magnetic poles are excited to have different magnetic polarities on opposite sides of the axial position.

4. The actuator according to claim 1, wherein
the fixed body is an inner core, and the movable body is an outer rotor.

5. The actuator according to claim 3, wherein:
the core has four poles;
the multi-axis rotation supporting part includes a pivot shaft connected to the movable body positioned at the initial position and extending in a direction orthogonal to an axial direction of the coil; and
the torque generation section generates a torque for vertically rotating the movable body in two directions from the initial position via the pivot shaft.

6. The actuator according to claim 1, wherein
the magnet has a ring shape and has, on an inner periphery thereof, a plurality of magnetic pole pairs each having upper and lower different magnetic polarities, the magnet being provided such that magnetic poles of each of the plurality of magnetic pole pairs are alternately different in a circumferential direction.

7. The actuator according to claim 6, wherein
the magnet is constituted by a multipole ring in which all magnetic poles are integrally formed, or by separate upper and lower rings.

8. The actuator according to claim 1, wherein
the magnet is a neodymium bonded magnet.

9. The actuator according to claim 1, wherein
the movable body has a weight for inertia addition.

10. The actuator according to claim 1, wherein
the movable body is a weight section.

11. The actuator according to claim 10, wherein
a distance between the weight section and the multi-axis rotation supporting part is adjustable.

12. The actuator according to claim 1, wherein
the fixed body and the movable body constitute a resonance structure of 150 Hz or less, and the movable body is driven at a frequency of 150 Hz or less.

13. The actuator according to claim 1, wherein
a resonance frequency of the movable body is 20 Hz or less.

14. The actuator according to claim 1, further comprising:
a control section configured to input to the coil an input signal of supply power having a signal waveform that is asymmetric between positive and negative polarities, and to control driving of the movable body with asymmetric vibration in which a velocity of the movable body differs between drive directions.

15. The actuator according to claim 14, wherein
the input signal is a sawtooth wave.

16. The actuator according to claim 1, wherein:
the movable body is a weight section, and
the actuator further comprises:
a position detecting part that detects movement of the weight section; and
a control section that drives the torque generation section to apply vibration corresponding to a position of the weight section detected.

17. A force display device, comprising:
the actuator according to claim 1; and
a housing in which the actuator is mounted and that includes a grip portion gripped by a user, wherein
the movable body of the actuator is disposed to be movable in an outward direction with a center of gravity of the housing interposed between the movable body and the grip portion, the outward direction being a direction away from the center of gravity of the housing.

18. An operation apparatus, comprising:
the actuator according to claim 1, wherein
the movable body is vibrated to perform force feedback by a torque generated by the torque generation section in response to movement of the movable body.
